(19) United States
(12) Patent Application Publication
(10) Pub. No.: US 2005/0168999 A1
(43) Pub. Date: Aug. 4, 2005

(54) LED light for loading dock

(75) Inventors: Mathew Sommers, Sagamore Hills, OH (US); James Petroski, Parma, OH (US); Matthew Mrakovich, Streetsboro, OH (US); Mark Mayer, Sagamore Hills, OH (US)

Correspondence Address: Scott A. McCollister, Esq.;Fay, Sharpe, Fagan, Minnich & McKee, LLP, 1100 Superior Avenue, Seventh Floor, Cleveland, OH, 44114-2518, US

(73) Assignee: GELcore LLC

(21) Appl. No.: 10/946,434

(22) Filed: Sep. 21, 2004

Related U.S. Application Data
(60) Provisional application No. 60/541,479, filed on Feb. 3, 2004.

(51) Int. Cl. F21S 8/00

(52) U.S. Cl. 362/427; 362/240; 362/800; 362/396; 362/397; 362/430

(57) ABSTRACT

An LED light assembly includes a fixture housing, and at least one LED disposed in the fixture housing. The fixture housing can mount to a bracket that mounts to a wall.

This application claims the benefit of Application No. 60/541,479 filed Feb. 3, 2004, which is incorporated by reference.

### BACKGROUND OF THE INVENTION

A dock light typically mounts to an inside wall of a warehouse dock adjacent a large door on a loading platform. The dock light shines light outwardly from the warehouse towards the interior of a tractor trailer backed up to the loading platform. Damage can occur to the dock light when the doors to the warehouse come down on top of the dock light fixture or when forklifts used to unload the trailer impact the dock light fixture causing the fixture to be twisted, bent, or pulled from its mounted location.

Typically, dock lights have an incandescent light source attached to a C-shaped or U-shaped bracket that is attached to an end of a metal arm. The metal arm attaches to a mounting bracket, which mounts to a wall of the warehouse dock.

A dock light having a 5 mm LED light source is also known. The dock light having an LED light source includes a fixture housing that encloses a plurality of LEDs. The fixture housing includes fins or protrusions on the outside of the housing. Such fins or protrusions can be caught by a forklift entering or exiting the trailer resulting in the fixture being twisted, bent or pulled from its mounted location.

Accordingly, it is desirable to provide a dock light using an LED light source where the LED light source is a high power, long lifetime LED and the fixture is robust and not prone to being caught by a forklift. Furthermore, it is desirable to provide a dock light that returns to a neutral position after the light has been struck and moved away from the neutral position.

### SUMMARY OF THE INVENTION

An LED light assembly includes a fixture housing, a plurality of LEDs disposed in the fixture housing, a bracket adapted to mount to a wall, and a biasing member. The LED light fixture housing adjustably mounts to the bracket. The biasing member is adapted to return the fixture housing to a neutral position after a force that has moved the fixture housing out of the neutral position has been removed.

An LED light assembly for attachment to a C-shaped or U-shaped bracket includes a housing and an LED disposed in the housing. The housing includes first and second side walls and a protective lens between the side walls. Each side wall has a mounting structure for mounting to an associated C-shaped or U-shaped bracket. The mounting structures are aligned with one another.

A customizable LED light fixture includes a housing and a plurality of LEDs mounted in the housing. Customizable optics can mount over each LED or over a few LEDs. For example, a first optic can mount over a first LED of the plurality of LEDs, where the first optic is adapted to generate a first light beam pattern. Also, a second optic can mount over a second LED of the plurality of LEDs, where the second optic is adapted to generate a second light beam pattern. Such a configuration allows for different beam patterns to be provided depending on the beam desired for the environment in which the light will be used. The optics can also be removably mounted inside the housing so that the beam array can be easily customizable in that one optic can be removed and replaced with another optic to provide a different desired beam pattern.

### BRIEF DESCRIPTION OF THE DRAWINGS

FIG. 1 is a front perspective view of a first embodiment of an LED light fixture.

FIG. 2 is a front perspective view of a second embodiment of an LED light fixture.

FIG. 3 is a front view of FIG. 2.

FIG. 4 is a side view taken from the right side of FIG. 3.

FIG. 5 is a top view of FIG. 3.

FIG. 6 is an exploded view of a modular head of an LED light fixture.

FIG. 7 is a perspective view of the modular head of FIG. 6.

### DETAILED DESCRIPTION OF THE INVENTION

A dock lighting assembly 10 includes a fixture housing 12, a plurality of LEDs 14 enclosed in the fixture housing, and a bracket 16 for mounting the fixture housing to a wall or similar structure. The LED fixture depicted in the figures is suited for use in a warehouse loading dock; however, the LED light assembly does not have only to be used in a loading dock environment. To the contrary the loading dock fixture can be mounted elsewhere to provide light in a variety of environments.

The fixture housing 12 is an elongated paralleliped and includes a plurality of side walls 18, a top wall 22 and a base wall 24. The fixture housing in the embodiments depicted is generally referred to as a low profile lighting fixture. The side walls, top wall and base wall are made of robust materials that can thermally control the heat output of the high power LEDs 14. The fixture housing 12 is manufactured from materials that also allow repeated impacts from forklifts and the like while not to suffering performance losses. The side walls 18, the top wall 22 and the base wall 24 are generally planar and smooth providing only minimal points of snag from forklifts and the machinery conventionally used to unload commercial trucks. A smooth housing allows a forklift operator to enter into a trailer without having to move the fixture assembly 10 out of the way.

A forklift operator can run into the fixture assembly 10, upon contact the fixture assembly swings out of the way, undamaged, and the forklift operator can proceed into the trailer. The bracket 16 is adapted to return the fixture housing 12 to its original (neutral) position. The forklift operator picks up the load, returns backwards, hits the fixture housing 12 again, and the fixture housing will swing safely out of the way without the operator needing to adjust the light fixture housing 12. Again, the bracket returns the fixture housing 12 to its neutral position.

The light fixture housing includes a protective lens 26 placed over the LED's 14. The protective lens 26 can be removable to allow customizable options by the end customer. The protective lens 26 can be made from differing lens materials to provide a protective lens that is diffuse, clear, or some combination in between. The protective lens is also made of a durable material that can withstand impacts from forklifts and the like.

A post 28 extends from the base wall 24 of the housing 12 to attach the fixture housing 12 directly to the bracket 16. Conventional loading dock lights include an arm that extends from the bracket and the incandescent light fixture attaches to a distal end thereof. In the present embodiment, however, the fixture 12 attaches directly to the bracket and the long arm is removed from the assembly. The post 28 attaches to an annular sleeve 32. The connection between the housing 12 and the post 28 is a conventional connection that allows the housing to rotate about a central axis of the post.

This axis is also parallel to the length of the fixture housing 12. The housing 12 can also rotate about a central axis of the annular sleeve 32, which will be explained in further detail below.

The bracket 16 includes a base wall 34, spaced-apart side walls 36 and 38, and a strut 42. The bracket 16 is preferably made of metal. The base wall 34 includes openings 44 to receive conventional fasteners (not shown) to mount the bracket 16 to a wall (not shown). The first side wall 36 extends upwardly substantially perpendicular from a first end of the base wall 34. The second side wall 38 extends upwardly substantially perpendicular from a second end of the base wall 34. Accordingly, the first side wall 36 is spaced from the second side wall 38. The first side wall 36 includes a side wall opening (not visible). Likewise, the second side wall 38 includes a side wall opening (not visible) aligned with the side wall opening in the first side wall 36.

A rod 52 is received in each side wall opening and by the annular sleeve 32. In one embodiment, the rod 52 can rotate inside the side wall openings. As the rod 52 rotates the fixture housing 12 also rotates about the central axis of the rod 52. In another embodiment, the annular sleeve 32 rotates about the rod 52 and the rod does not rotate. The rod 52 is retained by a nut 54 adjacent the first side wall 36. A washer 56 can be interposed between the nut 54 and the first side wall 36. The rod 52 is retained by a nut 58 attached to the rod adjacent the annular sleeve 32. Washers 62 and 64 can be positioned on opposite ends of the annular sleeve 32.

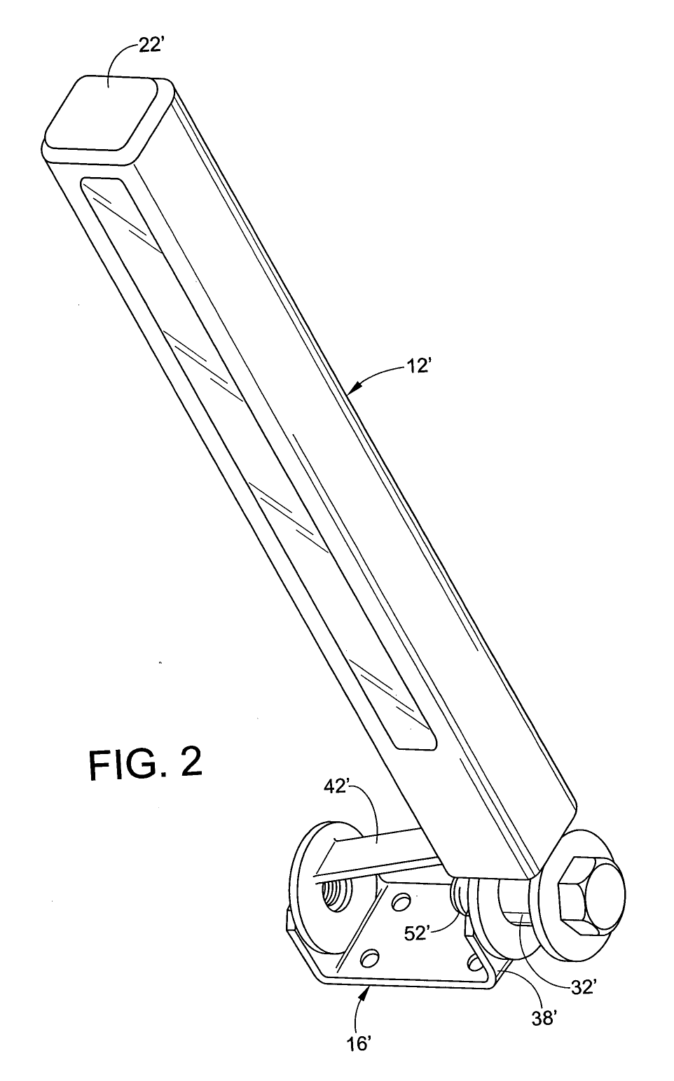

With reference to FIGS. 2-5, an alternative lighting assembly is disclosed where a like components are designated with the like numerals having a primed (′) suffix. In this embodiment, the rod 52′ does not run the length of the bracket 16′. The rod 52′ is received in an opening (not visible) in the second side wall 38′. The rod 52′ is received by the sleeve 32′ and the fixture housing 12′ rotates about the central axis of the sleeve 32′.

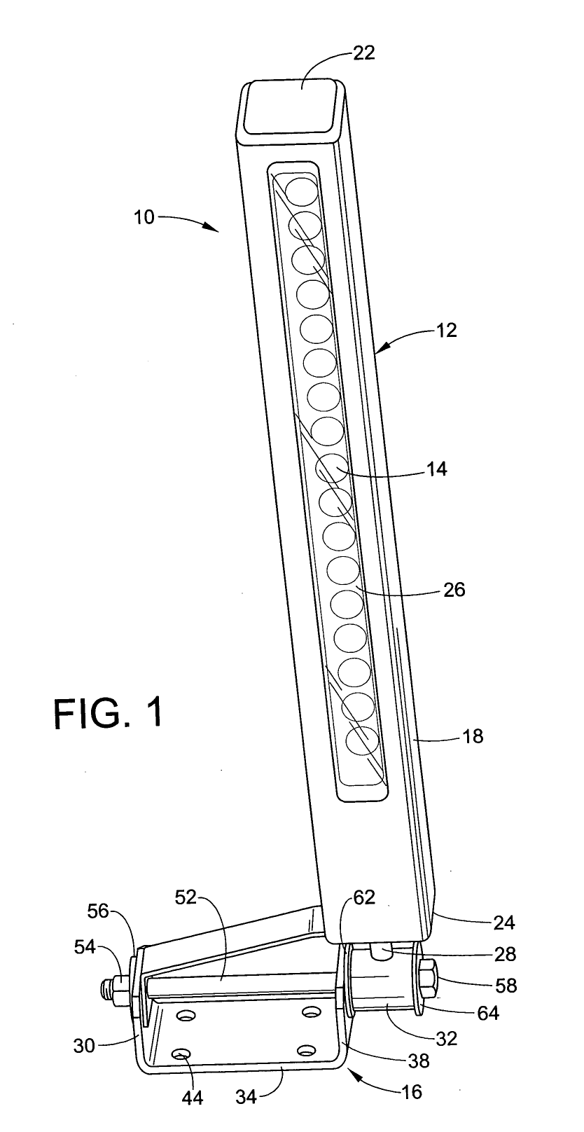

With reference back to FIG. 1, the strut 42 extends from the first side wall 36 of the bracket 16 towards the fixture housing 12. The strut 42 can be formed as an integral piece with the first side wall 36 or the strut can be a separate piece that abuts the first side wall. In the alternative where the strut abuts the first side wall, the strut can include an opening that receives the rod 52.

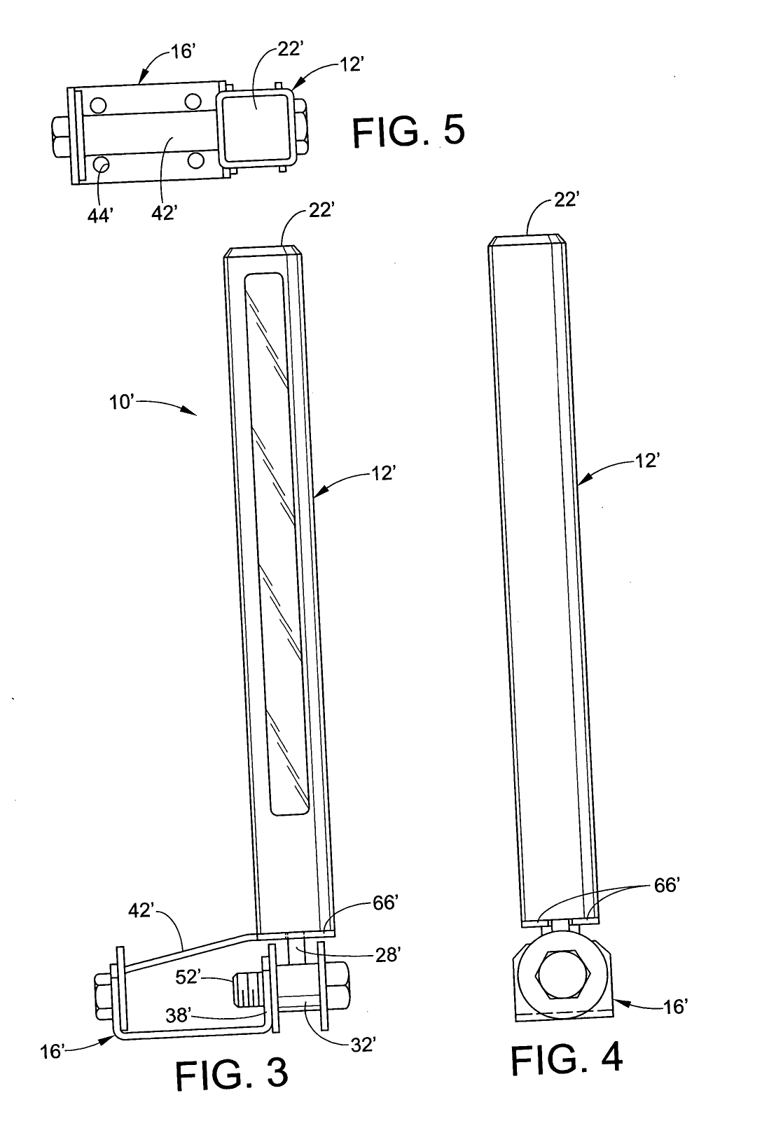

The strut 36 abuts the base wall 24 of the fixture housing 12. As seen in FIG. 3, the strut 42′ includes prongs 66′ (only one visible) that engage the bottom wall 24′ of the housing 12′. The post 28′ can be received between the two prongs 66′. The strut is made of a resilient material, such as a metal, and acts as a biasing member to center the fixture housing 12 in a neutral position after it has been struck. As the fixture housing 12 rotates about the axis of the sleeve 32, the strut 42 bends downward. As the force is released on the housing, the potential energy stored in the resilient strut 42 biases the housing back toward a neutral position. Accordingly, if the fixture housing 12 is mounted in a horizontal position, the strut 42 can bias the fixture housing 12 along a vertical axis and if the fixture housing 12 is mounted in a vertical position, the strut 42 can bias the fixture housing 12 along a horizontal axis.

The housing 12 can be biased to a neutral position in other manners. For example, a biasing member, such as a torsion spring, can be located in the sleeve 32 to bias the housing 12 to a neutral position. In yet another alternative, a biasing member can attach to the strut 42 and the base wall 34. Other known conventional biasing mechanisms are also contemplated such as a cam arrangement that uses gravity to align the housing 12.

The LEDs 14 can be any conventional LED and in the embodiment depicted in FIG. 1 run along an axis parallel with the length of the fixture housing. Preferably, the LEDs are high power LEDs, either generating white light, or of RGB white light generations. An optical system can be provided in the fixture housing to collect the light and direct it towards different areas. For example, LED arrays with different viewing angle optics within the fixture can be provided to achieve a specific beam pattern and light distribution. For example, the LED array can be optimized and aimed to provide a trapezoidal beam pattern which is known in the art. Alternatively, the LEDs can operate without an optical system in cases where a much wider flood light pattern is desired.

The LEDs 14 receive power from an externally mounted power supply. An externally mounted power supply allows low voltage wiring to the fixture housing 12 which results in safer light assembly, for example, in case of a severe impact of the fixture housing. Also, an externally mounted power supply provides better thermal performance since the power supply thermal energy is not dissipated into the LED thermal system. Nevertheless, in an alternative embodiment, the power supply can be mounted internally into the fixture housing 12.

A thermal system for dissipating the heat generated by the LED is also provided in the fixture housing 12. The thermal system is designed to provide adequate heat transfer and surface area to enable long lifetime when the LEDs are thermally connected to the fixture housing. The thermal system can include fins or other surface area increasing pieces for thermal control. Additionally, an active cooling system can be employed to cool the LED assembly.

The fixture housing 12 including the LEDs 14 can attach to other structures besides the bracket 16, or the fixture housing including the LEDs 14 can be provided as a separate unit from the bracket. For example, the fixture housing 12 including the LEDs 14 can be provided as a separate unit from the bracket. For example, the fixture housing 12 including the LEDs 14 can be provided as a light source in a rugged environment such as a work light or perhaps a heavy equipment light. The smooth and robust housing 12 can provide a durable long lasting light, especially when using LEDs.

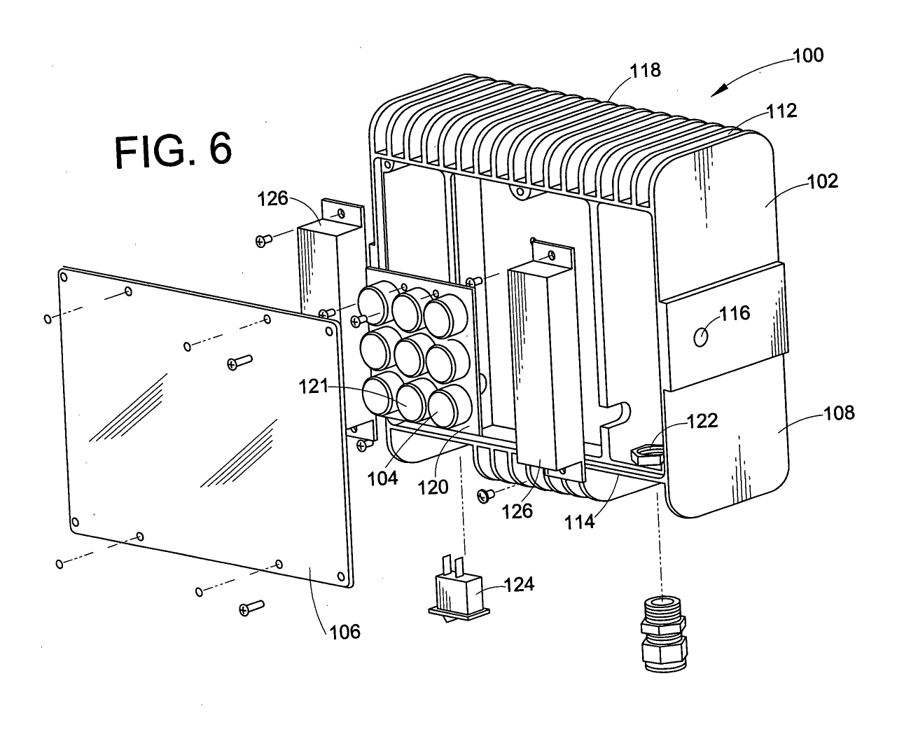

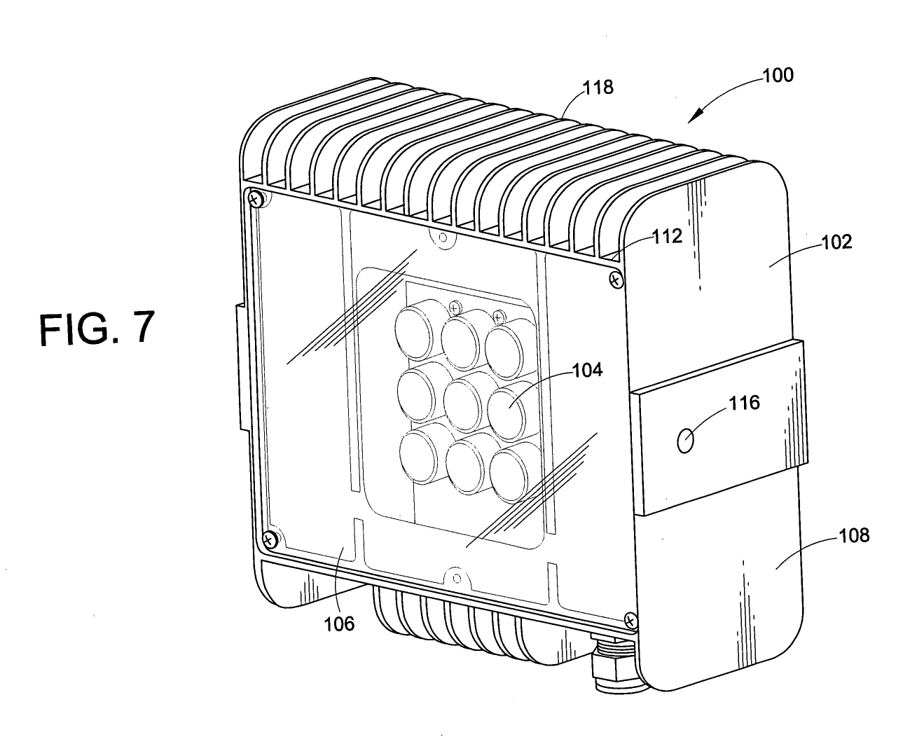

With reference to FIG. 6, a modular head 100 that is adapted to mount to the arm of a conventional dock light is shown. The modular head 100 includes a housing 102, a plurality of LEDs 104 enclosed in the housing, and a lens 106 that covers the LEDs. As mentioned earlier, the conventional dock light includes a C-shaped or U-shaped bracket that attaches to an arm (usually metal). The modular head 100 is adapted to mount to such a bracket. The housing 102 is generally box-shaped and includes planar side walls 108 (only one is shown), a top wall 112 and a base wall 114. The side walls 108 are spaced from one another so that the housing fits into the C-shaped or U-shaped bracket. Each sidewall includes an aligned opening 116 that receives a fastener to attach to the C-shaped or U-shaped bracket of the conventional loading dock light mounting structure. In an alternative embodiment, other mounting structures, such as pins that fit into openings in a bracket, can be provided. The head 100 can rotate about an axis running through the mounting structures. The top and bottom walls 112, 114 include fins 118 that protrude substantially normal to the top and bottom walls. The fins 118 can facilitate heat dissipation for the modular head 100 and can be in thermal communication with the LEDs 104. The housing 102 can be manufactured from materials similar to the housing 12 described above.

The LEDs can be similar to the LEDs 14 described above. The LEDs 104 mount to a printed circuit board (“PCB”) 120. Different beam patterns can be provided by the modular head 100 by changing one of the components on the array of LEDs. In FIG. 6, nine LEDs are shown on the PCB 120; however, a different number of LEDs can be provided. Furthermore, each LED is shown having a secondary optic 121 mounted overtop the LED. Each secondary optic 121 can generate a different beam angle. Accordingly, by changing the number of LEDs or the secondary optic on each LED, the array beam pattern can be changed.

The housing includes a conductor inlet 122 through which a power cord (not shown) can be received to power the LEDs 104. A switch 124 is in electrical communication with the power cord to operate the LEDs 104. A protective lens 106 is placed over the LEDs 104 and attaches to the housing 102. The protective lens 106 can be removable to allow customizable options by the end user. Furthermore, the lens can be made of material similar to the protective lens 26 described above.

In addition to receiving power from an external source through the power cord, the modular head can be provided with integral power supplies 126 that are in electrical communication wit the switch 124 and the LEDs 104. The power supplies can include batteries as well as some sort of rechargeable power source. Furthermore, the power supplies 126 can be in thermal communication with the fixture housing 112 to facilitate heat dissipation.

A light assembly has been described with preference to preferred embodiments. Obviously, modifications and alterations will occur to those skilled in the art. The invention is defined as including all such reasonable modifications and alternations that come within the spirit and scope of the appended claims.

1. An LED light assembly comprising:
a fixture housing;
a plurality of LEDs disposed in the fixture housing;
a bracket adapted to mount to a wall or other structure, wherein the fixture mounts to the bracket such that the fixture housing can move in relation to the bracket; and
a biasing member for biasing the fixture housing towards a neutral position in relation to the bracket.

2. The LED light assembly of claim 1, wherein fixture housing comprises an elongated paralleliped having a protective lens disposed over the LEDs.

3. The LED light assembly of claim 2, wherein the protective lens is selectively removable from the fixture housing.

4. The LED light assembly of claim 2, wherein the fixture housing comprises a plurality of smooth side walls.

5. The LED light assembly of claim 1, wherein the plurality of LEDs are disposed along the length of the fixture housing.

6. The LED light assembly of claim 1, wherein the fixture housing mounts to the bracket such that the fixture housing rotates in relation to the bracket.

7. The LED light assembly of claim 1, wherein the plurality of LEDs generally run along a first axis and the fixture housing mounts to the bracket such that the fixture housing rotates about a second axis, which is at least generally perpendicular to the first axis.

8. The LED light assembly of claim 1, wherein the fixture housing attaches to an annular sleeve and the annular sleeve attaches to the bracket.

9. The LED light assembly of claim 8, wherein the plurality of LEDs generally run along a first axis and the fixture housing mounts to the bracket such that the fixture housing rotates about a second axis, which is at least generally perpendicular to the first axis, and the fixture housing rotates about an axis aligned with or generally parallel with the first axis.

10. An LED light assembly for attachment to a C-shaped or U-shaped bracket, the assembly comprising:
a housing comprising first and second side walls and a protective lens positioned between the side walls, each side wall having a mounting structure for mounting to an associated C-shaped or U-shaped bracket, wherein the mounting structures are aligned with one another; and
an LED disposed in the housing.

11. The assembly of claim 10, wherein the housing includes an opening for receiving a power cord to deliver power to the LED.

12. The assembly of claim 10, wherein the housing includes a plurality of fins extending outwardly from the housing.

13. The assembly of claim 10, further comprising a top wall connecting the first and second side walls, and a plurality of fins extending from the top wall.

14. The assembly of claim 13, wherein the fins extend from the top wall in a direction generally parallel to the side walls.

15. The assembly of claim 13, further comprising a bottom wall connecting the first and second side walls, and a plurality of fins extending from the bottom wall.

16. The assembly of claim 10, wherein the mounting structures comprise openings adapted to receive a fastener.

17. A customizable LED light fixture comprising:
a housing;
a plurality of LEDs mounted in the housing;
a first optic mounted over a first LED of the plurality of LEDs, wherein the first optic is adapted to generate a first light beam pattern; and
a second optic mounted over a second LED of the plurality of LEDs, wherein the second optic is adapted to generate a second light beam pattern.

18. The light fixture of claim 17, further comprising a removable protective lens cover mounted to the housing over the plurality of LEDs.

19. The light fixture of claim 18, wherein each optic is selectively removable to allow the changing of the optic to provide a different light beam pattern.

20. The light fixture of claim 17, further comprising an optic removably mounted over each LED of the plurality of LEDs.
